(19) United States
(12) Patent Application Publication
(10) Pub. No.: US 2015/0276963 A1
(43) Pub. Date: Oct. 1, 2015

(54) CAPACITIVE SENSOR FOR DETECTING THE PRESENCE OF AN OBJECT AND/OR OF AN INDIVIDUAL

(71) Applicant: BOSTIK SA, La Plaine Saint Denis (FR)

(72) Inventors: Jessie Casimiro, Brie Comte Robert (FR); Philippe Mabire, Courcouronnes (FR); Stephane Hole, Paris (FR); Jerome Lucas, Massy (FR); Cedric Margo, Creteil (FR); Stephane Germain, Brie Comte Robert (FR)

(21) Appl. No.: 14/433,243

(22) PCT Filed: Sep. 11, 2013
(86) PCT No.: PCT/FR2013/052086

§ 371 Date: Apr. 2, 2015

(30) Foreign Application Priority Data
Oct. 5, 2012 (FR) 12 59492

(51) Int. Cl. G01V 3/08

(52) U.S. Cl. CPC G01V 3/088

(57) ABSTRACT

Disclosed is a capacitive sensor (100) for detecting an object and/or individual, characterised in that it includes at least three slender electrodes E1, E2 and E3 lying substantially in the same plan P and separated from one another over all or part of their length by a substantially constant given separation distance d2 and d3, which is for example around a few millimetres

### TECHNICAL FIELD

The present invention is situated in the field of detecting the presence of an object and/or individual.

One of the objectives of the present invention is instrumenting a floor with one or more capacitive sensors able to detect the presence or not of an object and/or an individual.

The subject matter of the present invention thus finds an advantageous application for detecting the fall of an aged person in a room where the floor is instrumented with one or more capacitive sensors: the present invention is therefore particularly interesting for buildings, medicalised or not, dedicated to aged persons such as for example retirement homes.

Naturally other advantageous applications can be envisaged in the context of the present invention, in particular in the security field (for example in museums, private houses, public premises, etc.) or in the automobile field.

### TECHNOLOGICAL BACKGROUND

Hygiene and health conditions are improving in the majority of countries, which results in particular in an increase in life expectancy.

Thus, in Europe, the average age of the population is increasing regularly. Projections to 2060 reveal that the proportion of persons aged more than 65 years should reach more than 50% of the total population, as against scarcely 20% currently.

This general aging of the population is leading health workers to find solutions for ensuring for aged persons their independence for as long as possible, with a minimum of assistance.

Among the various problems raised by this general aging, one of the challenges is to establish systems for detecting falls of aged persons.

This is because, every year, too many falls involving hospitalisation since the fall was not detected in time are recorded: generally, the health of the person deteriorates when treatment after the fall is too late.

Fall-detection systems exist in the prior art.

Among these systems there are:

those that must be carried permanently such as “anti-fall” patches, or

those that are intrusive, such as for example telemonitoring systems with image processing.

Nevertheless, other systems exist for detection avoiding the above drawbacks.

To this end, the document WO 2006/130081 proposes a method for detecting persons when getting out of bed. The method proposed in this document is particularly suitable for aged and/or disabled persons.

More precisely, pressure sensors, introduced into a polyurethane film, are connected to a monitoring system that triggers an alarm when pressure is exerted on the sensors.

Nevertheless, this method using pressure sensors is not suitable for the detection of falls. This is because, with such a method, it is impossible to differentiate a person walking from a person falling.

The document WO 2009/050285 for its part proposes a floor carpet instrumented with a system composed of sensors. This system uses capacitance in relation to the deformation of an intermediate layer in order to detect the presence either of a person or of an object.

Nevertheless, the sensors introduced into this carpet are not suitable for specifically detecting transfers of loads related to the presence of a person or object.

Although interesting, the various solutions above do not allow fine detection of falls of persons. Moreover, installing the solutions proposed above is very expensive, difficult and tedious to implement.

Alternatively, incorporating capacitive sensors in the floor of a room makes it possible to detect non-intrusively the presence of persons on the surface by measuring the variation in a physical quantity.

This is because a person on the floor can be assimilated to a local variation in permittivity or to the presence of a new electrode. In this context, capacitive sensors are sensors of choice for detecting persons. This is because capacitive sensors function as capacitors and their capacitance varies when an object or an individual approaches. This variation in capacitance makes it possible to determine the presence or not of an object or individual close to the sensor.

The document FR 2 956 137 uses such capacitive sensors and proposes an instrumented floor for presence detection. In this document, the floor comprises:

a sublayer consisting of an electrically insulating material placed on a slab,

capacitive sensors placed on the sublayer, and

a screed placed on the sublayer, this screed being insulating and covering the sensors.

In this document, it is indicated that disposing a sublayer consisting of an electrically insulating material is essential for affording effective detection with the capacitive sensors.

Installing an instrumented floor according to the document FR 2 956 137 with such an electrically insulating sublayer is complex and expensive.

Thus it turns out that none of the documents of the prior art proposes a solution that is effective, simple to install and satisfactory making it possible to detect the presence or not of an object and/or individual on the floor.

### SUBJECT MATTER AND SUMMARY OF THE PRESENT INVENTION

One of the objectives of the present invention is to improve the current situation described above by remedying the drawbacks mentioned above.

To this end, the subject matter of the present invention concerns a capacitive sensor for detecting the presence of an object and/or individual.

The concept underlying the present invention is adapting the geometry of the capacitive sensor; more precisely, the present invention provides for a specific arrangement of the electrodes constituting the sensor in order best to adapt to the physical properties, and in particular to the dielectric properties, of the object and/or individual the presence of which must be detected.

Thus, according to the present invention, the capacitive sensor comprises at least three slender electrodes that extend substantially in the same plane and are separated from one another over all or part of their length by a given separation distance.

This separation distance is substantially constant.

Preferably, this separation distance is around a few millimetres.

With such a configuration, it is not necessary to install an electrically insulating sublayer in order to correctly detect the presence of a person or object.

According to the present invention, the electrodes are biased independently of one another; this makes it possible to have independent measurements, which makes it possible to collect different information from one electrode to another.

Having different sensitivities for each electrode, biased independently of the other electrodes, makes it possible to adapt the sensitivity of the sensor electronically in order to precisely detect the presence of an object and/or a person.

The advantage of having at least two peripheral electrodes surrounding a central electrode is to limit the range of the electrical field generated when the central electrode is biased and the peripheral electrodes that surround it are earthed.

The presence of an earthed electrode on either side of the biased electrode limits the range of the electrical field approximately to the inter-electrode distance along the two axes of the plane on which the electrodes lie.

Thus the measurement phases consisting of measuring the signal on the central electrode when one or more electrodes are biased give information on the changes in the environment.

On the other hand, the measurement phase consisting of measuring the signal on the other electrodes gives information on the object and/or persons close to the sensor.

By combining the various measurement phases, it is therefore possible to separate the various items of information and thus to have a precise estimation of the situation.

In an advantageous variant embodiment of the present invention, the capacitive sensor comprises at least three electrodes, including a central electrode having a given radius of curvature and at least two peripheral electrodes positioned on either side of the central electrode.

In this variant, the axial distance between the axes of each electrode adjacent to one another is substantially between around three to five times this radius of curvature, preferably when the latter is between around 0.05 to 1 millimetre.

This ratio between the radius of curvature of the central electrode and the axial distances is one of the advantageous features of the present invention: this ratio makes it possible to have very fine detection of the presence or not of objects and/or individuals when they are close to the sensor.

As mentioned above, the radius of curvature of the central electrode is preferably between substantially around 0.05 to 1 millimetre.

It has been observed by the applicant that there is no appreciable effect on the functioning and performances of the sensor when the central electrode has a radius of curvature substantially between around 0.05 to 1 millimetre and when the electrodes of the sensor are positioned with respect to one another in compliance with a ratio between the axial distance and the radius of curvature of between 3 to 6.

These ratios and distances offer satisfactory performances that at least partially solve the various problems stated above.

According to the invention, the central electrode has a cross section with an elliptical shape (squashed round shape). This elliptical shape is therefore defined in particular by its radius of curvature. A person skilled in the art will understand here that, when the central electrode has a cross section forming a disc (a round shape), the radius of curvature can be assimilated to a radius.

Advantageously, at least one electrode from the three electrodes of the capacitive sensor according to the present invention is of the single filament type (that is to say is formed by a single wire).

Advantageously, the three electrodes of the capacitive sensor according to the present invention are integrated in a protective sheath such as for example a cable and thus form a layer of electrodes; this assists the maintenance in position of the electrodes with respect to one another and thus maintains a substantially constant separation distance between the electrodes.

According to an advantageous variant embodiment, the capacitive sensor comprises at least four electrodes. In other words, one electrode has been added.

According to the present invention, this fourth electrode is also biased independently of the other electrodes.

Preferably, this added electrode is of the single filament type.

The advantage of adding such an electrode is to break the symmetry of the sensor. This increases the number of independent measurements and thus improves the precision of detection: this is because, the more independent measurements there are, the less complex is the estimation of the recognition of the measured situation.

In this variant, this electrode, said to be offset, is separated from each of the other electrodes by a spacing distance that is substantially equal to at least ten times the separation distance.

The advantage of this asymmetric geometry through the addition of at least one electrode offset from the other electrodes is to obtain variable ranges making it possible to use the measurement phases as independent information.

By way of non-limitative example, the short-range measurement phases (that is to say those consisting of balancing one of any of the electrodes and measuring the signal on the central electrode of the multifilament part) preferentially make it possible to follow any environmental drifts related for example to changes in temperature and the ambient humidity.

The medium-range measurement phases (that is to say those where the measuring electrode is the one alongside the offset electrode) make it possible to limit the influence of the earth coupling.

Finally, the long-range measurement phases (that is to say those where the measuring electrode is one of the two peripheral electrodes) make it possible to evaluate the earth coupling and therefore to estimate the size of the object or person detected.

Advantageously, the capacitive sensor according to the present invention comprises an electronic processing box that is configured so as to collect and process the electrical signal or signals emitted by each electrode when for example an object and/or individual is close to the capacitive sensor.

Preferably, the electronic processing box is also configured so as to determine, according to the electrical signals emitted by each electrode, the presence or not of an object and/or individual close to the capacitive sensor.

Preferably, this determination is done using a pre-established experimental database comprising the information relating to the various possible scenarios: for example fall of person, passage of a domestic animal, etc.

The capacitive sensor described above, through its geometry of structure, is particularly effective in terms of detection, since it makes it possible to generate precise and independent electrical signals in order to detect falls of persons with good precision. In addition, this structure is particularly simple to deploy on the floor since it does not require an electrically insulating layer.

Correspondingly, the subject matter of the present invention relates to a floor structure for detecting the presence of an object and/or individual.

Floor, in the present invention, means here any system that has a structure comprising in particular a screed, and optionally a primer, a waterproofing barrier, a rendering, a finishing layer, a layer of adhesive, and/or a covering layer.

According to the present invention, the floor structure comprises at least one capacitive sensor as described above.

The instrumentation of the floor with at least one capacitive sensor as described above makes it possible to obtain a system that is particularly simple to install, such a floor being suitable for detecting the presence of an object and/or individual.

By virtue of the present invention, instrumentation of the floor can be envisaged for inhabited premises that are in the course of renovation and buildings in the course of construction.

According to an advantageous variant embodiment, the floor structure may have a finishing layer, which consists for example at least partially of mortar based on organic and/or mineral binder.

Preferably, in this variant, the capacitive sensor is embedded in a protective sheath, which may be polymeric, and which itself may be integrated in the finishing layer.

Preferably, this protective sheath is self-adhesive.

This variant is particularly advantageous for implementing the invention in the construction of a building or at least during the renovation of floors. Such an installation is particularly robust.

According to another variant embodiment, the floor structure may have a coating layer.

Coating layer means here, for example and non-limitatively, a layer such as a parquet, tiling, a flexible covering such as knitted, tufted, woven or flock carpet or a carpet in strip or tile form, a needled floor covering, in strips or tiles, a homogeneous or heterogeneous floor covering based on polyvinyl chloride on a jute or polyester base or on a polyester base with an underside made from polyvinyl chloride, a floor covering being based on polyvinyl chloride on foam, a floor covering based on polyvinyl chloride with a support based on cork, a floor covering based on expanded polyvinyl chloride, a semi-flexible slab based on polyvinyl chloride or an agglomerate cork slab with a wearing layer based on polyvinyl chloride.

Advantageously, in this variant, the capacitive sensor is fixed by adhesive bonding, directly or indirectly, to at least one portion of the bottom face of the covering layer.

Alternatively, the floor structure may also have a finishing layer fixed to the covering layer by means of a layer of adhesive. In this case, the capacitive sensor may be at least partially embedded in the adhesive layer.

According to another alternative variant, the floor structure may have a covering layer that preferably consists at least partially of one of the materials cited above. In this case, the capacitive sensor may be integrated in the covering layer.

Thus the floor structure according to the present invention offers several possible alternatives allowing instrumentation of the floor for detecting the presence of an object or individual.

By virtue of its various structural and functional features, the subject matter of the present invention makes possible, by varying the geometry of the electrodes, detection suited to various scenarios: fall of person, intrusion of person in a room or in a secure zone, passage of a domestic animal, etc.

Such sensors may easily instrument a floor without requiring an electrically insulating sublayer as is the case in the prior art.

### BRIEF DESCRIPTION OF THE ACCOMPANYING FIGURES

Other features and advantages of the present invention will emerge from the following description with reference to the accompanying FIGS. 1a-1e to 4a-4b, which illustrate various example embodiments thereof without any limitative character, and in which:

FIGS. 1a and 1b depict respectively, schematically, a plan view and view in cross section of a capacitive sensor according to an advantageous example embodiment of the present invention;

FIGS. 1c and 1d each depict schematically a view in cross section of a capacitive sensor in accordance with two other variant embodiments of the present invention;

FIG. 1e depicts schematically a plan view of a capacitive sensor according to an advantageous variant embodiment of the present invention;

FIG. 2 depicts schematically a plan view of a capacitive sensor according to another advantageous example embodiment of the present invention;

FIGS. 3a to 3d each depict a schematic view in cross section of a floor structure according to an example embodiment of the present invention; and

FIGS. 4a and 4b depict tables of experimental values showing the influence of the distance between the electrodes in a capacitive sensor according to the present invention.

### DETAILED DESCRIPTION OF VARIOUS ADVANTAGEOUS EXAMPLE EMBODIMENTS

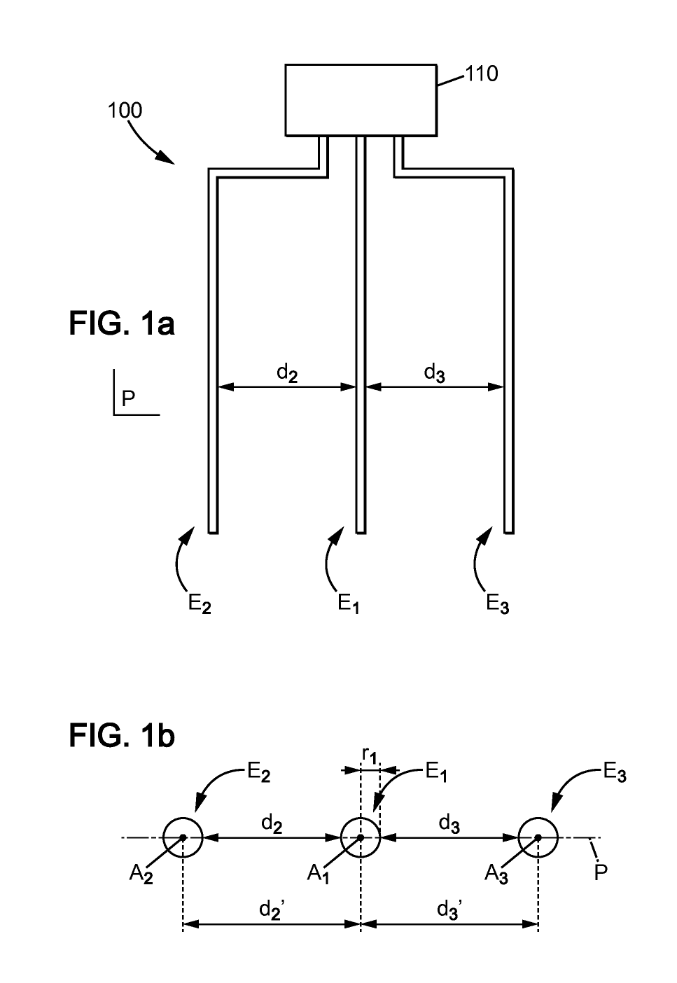

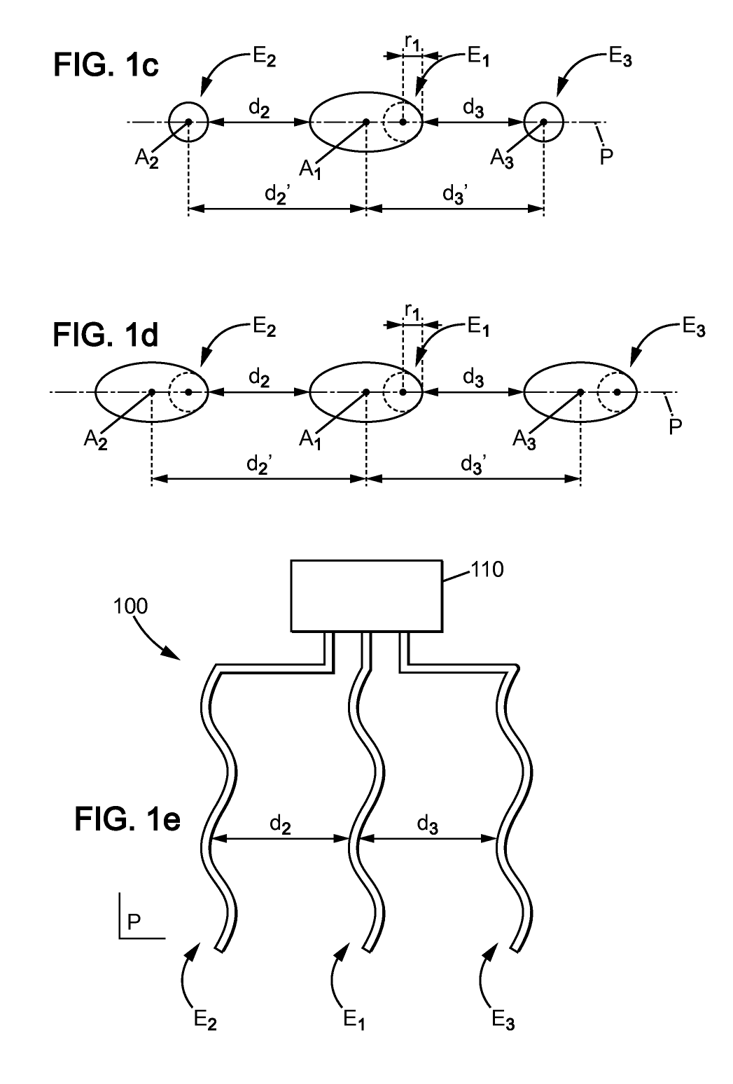

Several capacitive sensors and floor structures according to various advantageous example embodiments of the present invention will now be described with reference conjointly to FIGS. 1a-1e to 4a-4b.

The examples described here are particularly suitable for an application of the type involving the detection of a fall of an aged person in a medicalised environment of the retirement home type. Naturally, as mentioned previously, other applications can also be envisaged in the context of the present invention.

As a reminder, allowing the detection of an object and/or individual close to the floor is one of the objectives of the present invention.

Designing a sensor suitable for instrumenting the floor while allowing easy installation of the sensor is also one of the objectives of the present invention.

To this end, the concept underlying the present invention is using the technology of capacitive sensors and varying several parameters thereof so that these sensors are suited both to their environment and to one of the scenarios that it is sought to detect, namely in the example described here the fall of persons.

Among the various parameters that can be varied according to the present invention, there are in particular: the number of electrodes, their size, their geometry, and the relative arrangement of these electrodes with respect to one another. By varying theses parameters, it is in particular possible to dispense with the presence of an electrically insulating layer as proposed in the document FR 2 956 137.

Having regard to the application referred to here, a “good” sensor 100 within the meaning of the present application is a sensor making it possible to detect the presence or not of a person lying on the floor.

To do this, the sensor 100 according to the present invention must be sensitive to what is situated above the covering layer 230 of the floor without being interfered with by its environment.

It is therefore necessary here to design a sensor 100 the sensitivity of the layer which is not zero above the covering layer 230. It is also necessary to design a sensor 100 the sensitivity of which is different according to the measurement phase.

Thus, by recovering different information for this same dielectric environment above the covering, it is possible to get round the effects of the disturbing elements such as a carpet, a film of water, or variations in humidity for example.

In order to control the sensitivity field of the sensor, a plurality of electrodes are necessary, on which biasing is imposed in order to be able to influence the distribution of the electrical field in space. The sensor 100 developed in the context of the present invention therefore comprises N electrodes that can be biased independently of one another.

Using N electrodes, where N is a positive integer greater than or equal to 3, makes it possible to have N(N−1)/2 independent measurements.

In the first example embodiment described here and illustrated in FIGS. 1a and 1b, the capacitive sensor 100 according to the present invention comprises three slender electrodes E1, E2 and E3: the electrode E1 is a so-called central electrode that is surrounded by two so-called peripheral electrodes E2 and E3.

In the example described here, these three electrodes E2, E2 and E3 extend longitudinally in a plane P (this plane defines for example the floor). As illustrated in figure la, the electrodes E1, E2 and E3 extend in a rectilinear fashion and are thus substantially parallel to one another over all or part of their length: each of the pairs of adjacent electrodes E2/E1 and E3/E1 is separated by a separation distance respectively d2 and d3 that is substantially constant over all or part of their length.

A person skilled in the art will understand here that the arrangement of the electrodes E1, E2 and E3 with respect to one another may have other geometries. By way of example, as illustrated in figure le, the electrodes E1, E2 and E3 may each have zigzags thus forming a succession of “Ss”, the important thing here being having a substantially constant separation distance over all or part of the length of the electrodes.

In the example described here and illustrated in FIG. 1a, the electrodes E1, E2 and E3 are designed to be able to be installed alongside one another in a linear fashion; in the example described here, the electrodes E1, E2 and E3 do however have, at the electronic box 110, elbows for simplifying the connection to the electronic box 110.

The electrodes E1, E2 and E3 may also have elbows for following the contours of the geometry of the room (not shown here) provided that the separation distances d2 and d3 between the electrodes E1, E2 and E3 are substantially equal over their entire length (except of course at the elbows).

As illustrated in FIG. 1b, the geometry that has been adopted here to obtain a detection of falls is to select a single-filament central electrode E1 the radius r1 of which is substantially equal to 0.3 millimetres, and separating the axis A1 of the electrode E1 from the axes A2 and A3 respectively of the electrodes E2 and E3 by an axial distance d2′ and d3′ substantially equal to 1.27 millimetres.

In the example described here, the ratio between each axial distance d2′ and d3′ and the radius of curvature r1 is substantially equal to approximately 4.2.

This geometry makes it possible to have particularly satisfactory measurements when a person is situated close to such a sensor 100.

A person skilled in the art will understand here that the electrodes may have other forms: thus, as illustrated in FIGS. 1c and 1d, the central electrode E1 and/or the peripheral electrodes E2 and E3 may have a cross section having an elliptical shape (or a “potato” shape). In this case, “radius of curvature” is spoken of In any event, the ratios indicated above between axial distances and radius of curvature (or radius) remain unchanged.

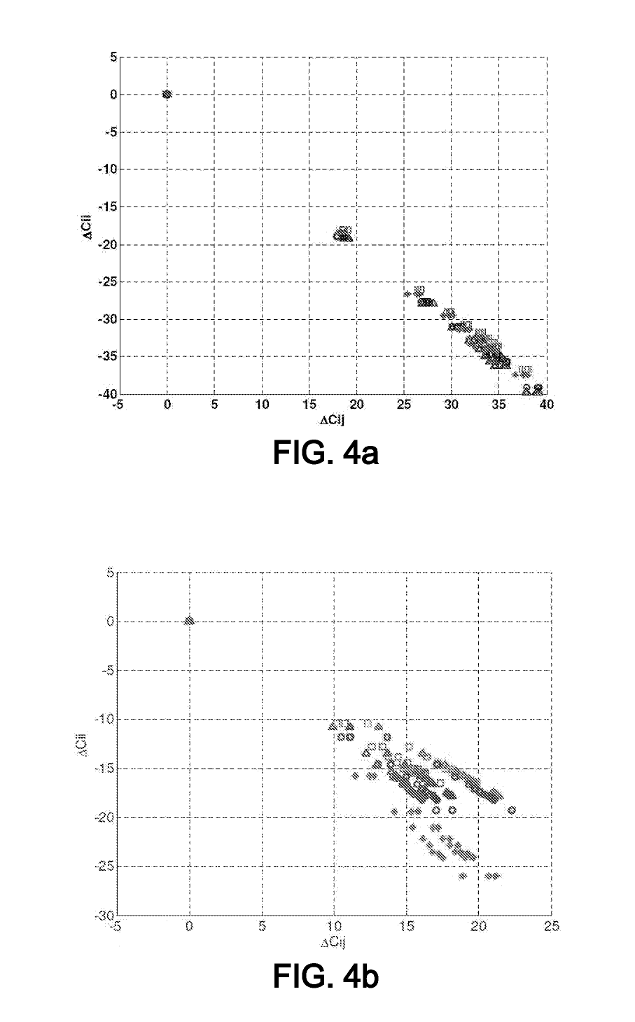

FIG. 4b shows the variations in inherent capacitances according to the inter-capacitances with a sensor as described above. As illustrated in this figure, the curve clusters are clearly differentiated from one another. These results thus show the difference between the measurement phases: the measurements obtained are independent of one another. This differentiation of the measurement phases makes it possible to envisage the distinguishing informative events from disturbing events.

These results therefore indicate that it is desirable to keep a ratio between axial distance d2′ or d3′ and radius (or radius of curvature) r1 of between around 3 to 6, provided that the radius (or radius of curvature) r1 is between around 0.05 to 1 millimetres. Compliance with these proportions between the distances d2′ and d3′ and the radius (or radius of curvature) r1 makes it possible to obtain precise and satisfactory results.

FIG. 4a for its part shows the variations in the inherent capacitances according to the inter-capacitances with a sensor not complying with the geometry proposed above (ratios and distances between electrodes). In this figure, there is almost no difference between the measurement phases: the various curve clusters are almost all identical. This figure thus shows that, when the distances between the electrodes are too great, the measurement phases produce an almost similar signal, which implies non-independence of the measurements, that is to say it is impossible to extract relevant information in the measurements.

The comparison of the measurement phases in FIGS. 4a and 4b therefore shows the importance of the geometry proposed in the context of the present invention.

Thus, by complying with the geometry indicated above, it is possible to independently measure the electrical field produced by each electrode E1, E2 and E3 when a person is close to the sensor 100, this field depending in particular on the above geometry and the distribution of the permittivity of the dielectric materials in the environment of the sensor.

The applicant observes that, if an electrode E1, E2 or E3 is too thin (that is to say has a radius of curvature r1 of less than 0.05 millimetres), the immediate environment of the electrodes E1, E2 or E3 then has a major effect on the electrical signal at the expense of the effects at a longer distance. This is because the electrical field decreases as 1/d in the vicinity of an electrode.

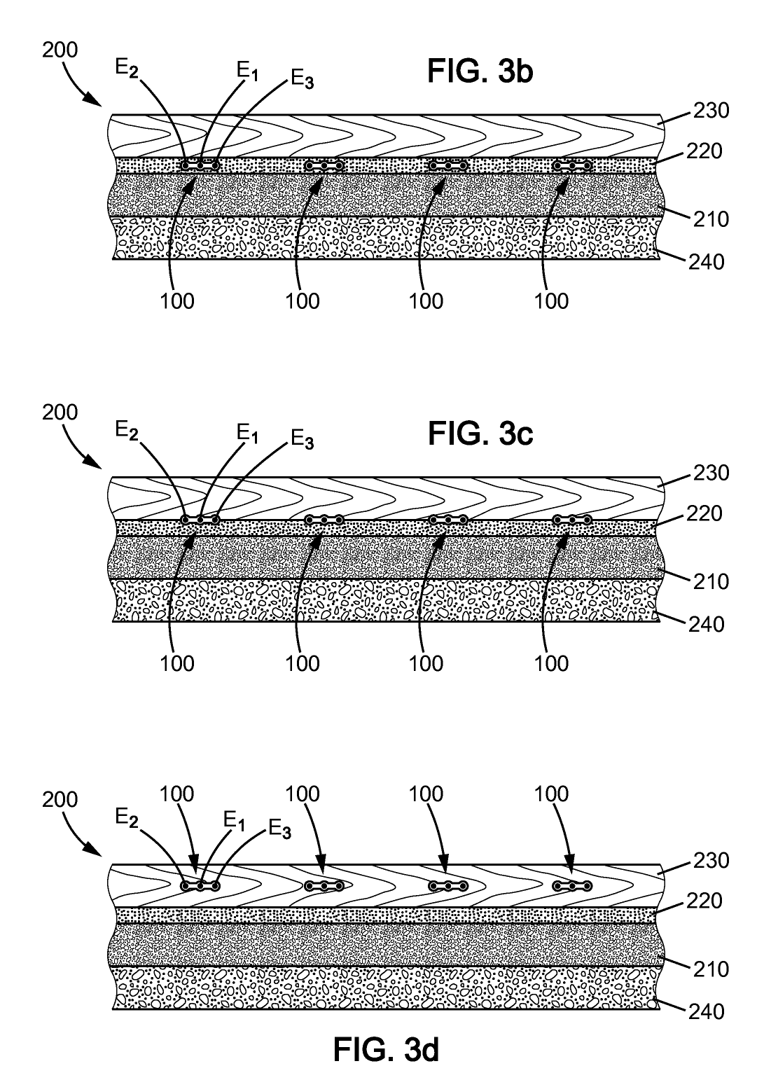

It is therefore reasonable that, in the context of the present invention, the electrodes E1, E2 and E3 have a radius of curvature having a value equivalent to half the mean diameter of the particles in the covering layer in which provision is made for them to be included: a mortar particle for example in the case where the sensor 100 is integrated in a finishing layer as illustrated in FIG. 3a.

Moreover, if the axial distance d2′ and d3′ between the electrodes E1, E2, E3 increases with respect to the radius of curvature r1, the influence of the external elements, in particular persons, is no longer differentiated between the measurement phases (see in particular FIG. 4a). Because of this, by using such electrodes, the advantage of working in multi-electrode mode would be lost.

This is due to the fact that the coupling between the electrodes becomes negligible compared with the coupling between an electrode and earth (or an electrode and a person). Thus, by no longer complying with this geometry and arrangement, each electrode E1, E2, E3 behaves in a similar manner (FIG. 4a). On the other hand, when the distances d2 and d3 (or d2′ and d3′) between the electrodes E1, E2, E3 are sufficiently low, the coupling is high: this differentiates the electrodes having strong coupling (the central electrode E1 for example) from the electrodes having a weaker coupling (the peripheral electrodes E2 and E3 for example). This geometry thus makes it possible to have independent results (FIG. 4b).

In the example described here in figure la, the capacitive sensor 100 according to the present invention comprises an electronic box 110 that is configured so as to collect and process the independent electrical signal or signals emitted by each electrode E1, E2 and E3 when for example an object and/or an individual is close to the capacitive sensor 100. This housing 110 is furthermore configured so as to determine, according to the electrical signals emitted by each electrode E1, E2 and E3 and a pre-established database, the presence or not of an object and/or individual close to the capacitive sensor 100.

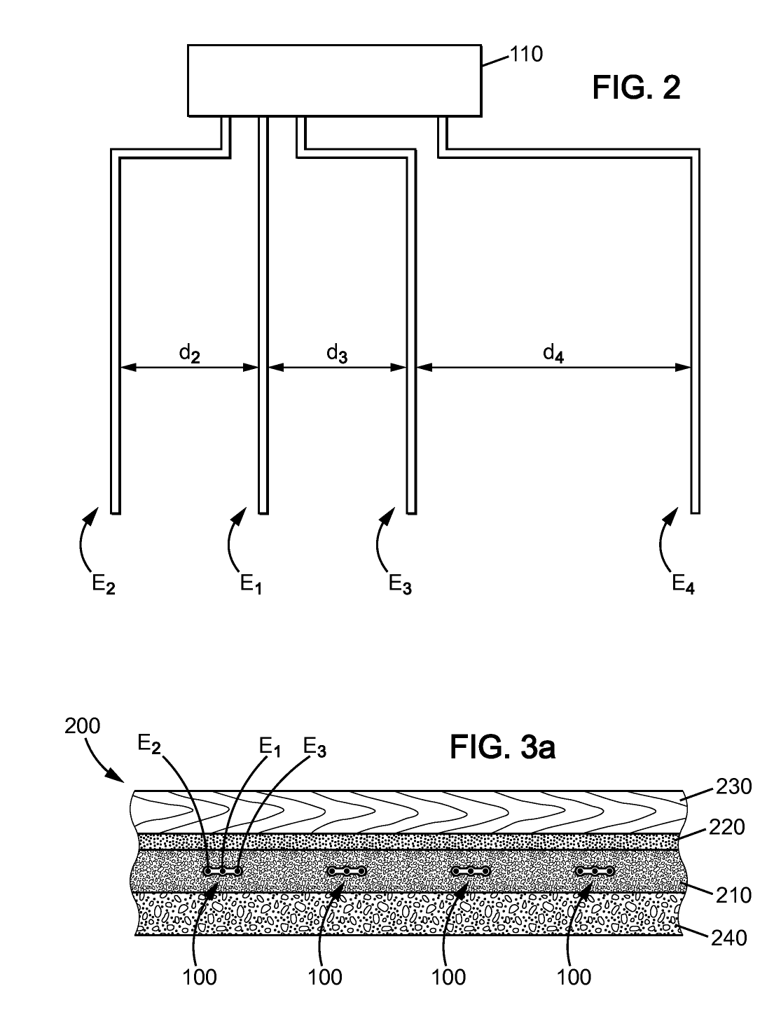

A second advantageous example embodiment illustrated in FIG. 2 comprises all the features described above for the first example embodiment and further provides for the addition of a fourth electrode E4 that is distant from the electrode E3 by a spacing distance d4 substantially equal to at least ten times the separation distance d2 or d3.

The specific positioning of this fourth electrode E4 according to this second embodiment makes it possible to have variable ranges making it possible to use the measurement phases as independent items for information and thus to dispense for example with environmental drifts.

This example of a sensor 100 having such an asymmetric geometry makes it possible to obtain a capacitive detection the measured coefficients of which are differentiated over the detection height and sensitive to the environment of the object or individual the presence or otherwise of which it is necessary to detect.

The sensor 100 according to the two example embodiments described here and illustrated in FIGS. 1a-1b and 2 is therefore particularly efficient. It can moreover be easily integrated in a floor structure 200, in particular because of the fact that it does not require the presence of an electrically insulating layer.

Various floor structures 200 are thus envisaged in the context of the present invention, each of these structures comprising at least one sensor 100 according to the first example embodiment in figures la and lb (see in particular FIGS. 3a to 3d). Quite obviously, it must be understood that integrating any other type of sensor 100 according to the present invention can be envisaged here (in particular those in FIG. 2: not illustrated here).

Thus the example embodiment in FIG. 3a provides for the incorporation of sensors 100 in a finishing layer 210.

In this example, in order to ensure easy implementation for the installer, the sensors 100 are embedded in a sheath, optionally polymeric, which may be perforated and self-adhesive. This sheath further guarantees the holding in position of the geometry and spacing between the electrodes E1, E2 and E3 of each sensor 100.

If the capacitive sensors 100 are introduced into the finishing layer 210, the floor instrumentation may for example be effected as follows: laying of the screed 240, application of an attachment primer layer on the screed 240, installation of the capacitive sensors 100 on the attachment primary layer, pouring of a finishing layer 210 on the sensor 100, application of a layer of adhesive 220 and a covering layer 230 on the dry finishing 210 instrumented with the sensors 100.

Thus an instrumented floor having such a structure 200 with the capacitive sensors 100 makes it possible to effectively detect persons close to the floor without the need to lay an additional insulating layer.

The example embodiments in FIGS. 3b and 3c provide for an instrumentation of the floor with sensors 100 placed directly or indirectly on the finishing layer 210.

In the example in FIG. 3b, the floor instrumentation is effected as follows: the capacitive sensors 100 are added between self-adhesive bands forming a layer of adhesive 220 placed on the finishing layer 210.

The example in FIG. 3c differs from the example in FIGS. 3b in that the capacitive sensors 100 are fixed by gluing directly to a portion of the bottom face of the covering layer 230.

Finally, according to a fourth example embodiment illustrated in FIG. 3d, the sensors 100 are directly introduced into the covering layer 230. In this example, the previous steps of the installation are repeated, having previously manufactured an instrumented covering layer 230 for example by weaving sensors 100 with the covering layer 230.

Thus the geometry of the electrodes E1, E2 and E3 as provided for in the context of the present invention is particularly advantageous and makes it possible to design a capacitive sensor 100 guaranteeing a fine and precise presence detection of persons and/or objects situated close to said sensor.

The sensors 100 thus obtained can easily serve for instrumenting a floor for an application for example in medicalised buildings and/or retirement homes, the floor structure 200 not here requiring the presence of an electrically insulated layer as is the case in the prior art.

It should be noted that this detailed description relates to particular example embodiments of the present invention but that under no circumstances does this description have any limitative character on the subject matter of the invention; quite the contrary, its objective is to remove any lack of precision or faulty interpretation of the following claims.

1-12. (canceled)

13. A capacitive sensor (100) for detecting an object and/or individual, comprising at least three slender electrodes (E1, E2, E3) extending substantially in the same plane (P) and separated from one another over all or part of their length by a substantially constant given separation distance (d2, d3), in which said at least three electrodes (E1, E2, E3) are biased independently of one another.

14. The capacitive sensor (100) according to claim 13, comprising a central electrode (E1) having a given radius of curvature (r1) and at least two peripheral electrodes (E2, E3) positioned on either side of the central electrode (E1), wherein the axial distance (d2′, d3′) between the axes of each electrode (E1, E2, E3) adjacent to one another is substantially between around 3 to 6 times the value of the radius of curvature (r1).

15. The capacitive sensor (100) according to claim 13, wherein at least one electrode (E1, E2, E3) from said at least three electrodes (E1, E2, E3) is of the single filament type.

16. The capacitive sensor (100) according to claim 13, wherein at least three electrodes (E1, E2, E3) are integrated in a protective sheath configured so that said electrodes are held in position.

17. The capacitive sensor (100) according to claim 13, comprising at least four electrodes (E1, E2, E3, E4), wherein one (E4) of said at least four electrodes (E1, E2, E3, E4) is separated from each of the other electrodes (E1, E2, E3) by a spacing distance (d4) equal to at least ten times the separation distance (d2, d3).

18. The capacitive sensor (100) according to claim 13, wherein it comprises an electronic processing box (110) configured so as to collect and process the electrical signal or signals emitted by each electrode (E1, E2, E3, E4) when for example an object and/or individual is close to said capacitive sensor (100).

19. The capacitive sensor (100) according to claim 18, wherein the electronic processing box (110) is configured so as to determine, according to the electrical signals emitted by each electrode (E1, E2, E3, E4), the presence or not of an object and/or individual close to said capacitive sensor (100).

20. A floor structure (200) for detecting an object and/or individual, wherein it comprises at least one capacitive sensor (100) according to claim 13.

21. The floor structure (200) according to claim 20, having a finishing layer (210), wherein said at least one capacitive sensor (100) is embedded in a protective sheath, preferably self-adhesive, itself integrated in the finishing layer (210), and wherein this protective sheath is polymeric.

22. The floor structure (200) according to claim 20, having a covering layer (230), wherein said at least one capacitive sensor (100) is fixed by adhesive bonding, directly or indirectly, to at least a portion of the bottom face of the covering layer (230).

23. The floor structure according to claim 22, having a finishing layer (210), wherein the covering layer (230) is fixed to the finishing layer (210) by means of a layer of adhesive (220), and wherein said at least one capacitive sensor (100) is at least partially embedded in the layer of adhesive (220).

24. The floor structure (200) according to claim 20, having a covering layer (230), wherein said at least one capacitive sensor (100) is integrated in the covering layer (230).
